(19) United States
(12) Patent Application Publication
(10) Pub. No.: US 2024/0328221 A1
(43) Pub. Date: Oct. 3, 2024

(54) Multi-Axis Door Hinge System

(71) Applicant: Lokaway Pty Ltd, Pakenham (AU)

(72) Inventor: Brett Dunstan, Pakenham (AU)

(21) Appl. No.: 18/579,457

(22) PCT Filed: Aug. 25, 2022
(86) PCT No.: PCT/AU2022/051007

§ 371 Date: Jan. 15, 2024

(30) Foreign Application Priority Data
Aug. 25, 2021 (AU) 2021221781

(51) Int. Cl. E05D 7/14; E05D 3/12; E05G 1/04

(52) U.S. Cl. CPC E05D 7/14; E05D 3/12; E05G 1/04

(57) ABSTRACT

A multi-axis door hinge system for a container, the system comprising: a door for enclosing a door frame of the container; a first hinge set, comprising one or more hinge(s) configured along a first hinge axis, mounted to or proximate an external side of the door frame; a second hinge set, comprising one or more hinge(s) configured along a second hinge axis, operatively mounted to an internal side of the door such that the door is rotatable about the second hinge axis, wherein the second hinge set is operatively coupled with the first hinge set so that the second hinge set is rotatable about the first hinge axis, thereby allowing both lateral and rotational movements of the door relative to the door frame.

### FIELD OF INVENTION

This invention relates to a door arrangement. More particularly, this invention relates to a secure door or security door arrangement. Still more particularly, this invention relates to a wide swing door arrangement. Most particularly, this invention relates to a wide swing secure door and door jamb arrangement.

### BACKGROUND

The following references to and descriptions of prior proposals or products are not intended to be, and are not to be construed as, statements or admissions of common general knowledge in the art. In particular, the following prior art discussion should not be assumed to relate to what is commonly or well known by the person skilled in the art, but to assist in the inventive process undertaken by the inventor(s) and in the understanding of the invention.

Secure door and door jamb arrangements have been described in which a door translates sideways to overlap a door jamb to improve resistance to forced entry through prying the door open. However these arrangements have been described to only have a swinging arc of around 90°. In such arrangements, access through the door jamb is restricted because the door, swung open to its fullest extent at, say, 90°, partially blocks the entrance.

The applicant has determined that it would be advantageous to provide an improved security door arrangement that seeks to at least in part ameliorate one or more of the aforementioned disadvantages of the prior art or to provide the public with a useful choice.

### STATEMENTS OF INVENTION

The invention according to one or more aspects may be as defined in the independent claims. Some optional and/or preferred features of the invention are defined in the dependent claims.

According to an aspect of the invention, there is provided a multi-axis door hinge system for a container, the system comprising: a door for enclosing a door frame of the container; a first hinge set, comprising one or more hinge(s) configured along a first hinge axis, mounted to or proximate an external side of the door frame; a second hinge set, comprising one or more hinge(s) configured along a second hinge axis, operatively mounted to an internal side of the door such that the door is rotatable about the second hinge axis, wherein the second hinge set is operatively coupled with the first hinge set so that the second hinge set is rotatable about the first hinge axis, thereby allowing both lateral and rotational movements of the door relative to the door frame.

In some embodiments, the door is configured to have a movement range of greater than 180° between a closed position, in which the door engages the door frame, and a fully open position.

In some embodiments, the first hinge set and the second hinge set are coupled by a connecting part extending through an opening in the door.

In some embodiments, the second hinge set comprises two hinges and wherein the hinges are coupled by an elongate hinge connection member.

In some embodiments, the second hinge set and/or the hinge connection member are coupled to the door by a plate member.

In some embodiments, the hinge system further comprises a locking mechanism actuable to move one or more locking bolts relative to the door frame.

In some embodiments, the locking mechanism comprises a handle mounted to an external side of the door for actuating the locking bolts.

In some embodiments, the locking mechanism comprises an arm connecting the handle to the hinge connection member so that actuation of the locking mechanism by the handle effects rotation of the door relative to the second hinge set.

According to a further aspect of the invention, there is provided a security container, comprising a container frame defining an enclosed space with an opening, and a multi-axis door hinge system as described herein for securing the opening.

Also described herein is a door and door jamb arrangement including a door, a door jamb and a door hinge, the door hinge being adapted to connect the door to the door jamb whereby the door is hingedly attached to the door jamb at a first side of the door jamb that is opposed to a second side of the door jamb, and the door jamb defines a door jamb zone and inner edge of which lies in a jamb plane, the door jamb zone being a three-dimensional space within the door jamb and surrounded by the door jamb on at least three sides to define a door jamb zone footprint having a general when viewed from a top elevation, wherein:
the door is adapted to translate sidewards relative to the door jamb through a plane substantially parallel to the jamb plane;
the door hinge includes at least first and second hinge axes that are non-coaxial relative to each other;
at least one of the first and second hinge axes is located outside of the door jamb zone footprint and on the first side of the door jamb; and
the door is adapted to swing out and away from the second side of the door jamb toward an open position.

Preferably, the first side being outside a secure space secured by the door and door jamb arrangement and the second side of the door being inside the secure space.

Preferably, the door hinge is adapted to extend through the door such that the door hinge includes components on the second side of the door and the first side of the door.

Preferably, the door hinge is adapted to extend through a hole in the door.

Preferably, the door hinge is not directly fixed to the hole.

Preferably, the door hinge includes an upper hinge and a lower hinge.

Preferably, the upper and lower hinges each include first and second hinges which include the first and second hinge axis respectively.

Preferably, the door is adapted to have a swing range of more than 170°.

Preferably, the door is adapted to swing between both a position parallel to the jamb plane and in the door jamb zone and a position parallel the jamb plane and outside the door jamb zone.

Preferably, the door is adapted to swing at least 180°.

Also described herein is a door and door jamb arrangement including a door, a door jamb and a door hinge, the door hinge being adapted to hingedly mount the door so that it is supported at a first side of the door jamb that is opposed to a second side of the door jamb, the door jamb arrangement having a door jamb zone in the form of a three-dimensional space with top, bottom, first and second side, and front and rear, extents, the extents being defined by the door jamb, the door jamb zone having a door jamb footprint with a general shape that follows the line or contour of the front and the rear extents when viewed from a top elevation, wherein: the door is adapted to translate laterally and partially through the door jamb zone in a direction including a vector parallel to the front or the rear extent; the door hinge includes at least first and second hinge axes that are non-coaxial relative to each other; at least one of the first and second hinge axes is located outside of the door jamb zone footprint and at or adjacent the first side of the door jamb; and the door is adapted to swing about the door hinge out and away from the second side of the door jamb toward an open position.

### Hinge

The hinge system may include more than two hinge axes. Preferably, the hinge system comprises two axes. The first hinge axis may be located on an external side of a door and the second hinge axis located on an internal side of the door. The external side of the door being outside a secure space, such as a safe, fortified room or a building. The internal side of the door being inside the secure space.

The hinge system may comprise multiple hinges attached to each other in alignment (such as parallel alignment) on either side of the door. Advantageously, the positioning of the hinge on or located proximate an external facing side (e.g. the outside) of the door may allow greater than 90 degrees hinged rotation of the door relative to the door jamb and/or about the hinge axes, between fully closed and fully open positions of the door. In some embodiment, the positioning of the hinge on the external facing side of the door may allow greater than 135 degrees rotation of the door about the hinge axes. In other embodiments, the positioning of the hinge on the external facing side of the door may allow greater than 170 degrees rotation of the door about the hinge axes. In further embodiments, the positioning of the hinge on the external facing side of the door may allow for greater than 180 degrees rotation of the door about the hinge axes.

The hinge system may comprise two or more independent hinges which are not attached to each other than through the door or door jamb. The hinge system may comprise a single hinge with multiple points of mounting to the door and door jamb. The single hinge may include multiple separate and connected hinges. Preferably, the hinge includes an upper and a lower hinge, each including a first and second hinge aligned in the first and second hinge axis respectively. Preferably, the second hinges of the upper and lower hinge are connected by a connection member, for example, in the form of a rod.

The rod may include housings or bearings which are fixed to the door.

The first hinge axis may be adapted to be located outside the secure space. The second hinge axis may be adapted to be located inside the secure space when the door is in a closed position.

The hinge may be welded, attached with fixtures or otherwise connected to the door and door jamb.

Preferably, the externally located and internally located hinges are adapted to extend or connected through a slit, channel or cavity in the door.

Preferably, the hinge is adapted to not be attached to the slit, channel or cavity in the door but rather move freely in the slit, channel or cavity. Therefore, the slit, channel or cavity may be adapted to accommodate movement of one or each of the first or the second hinge relative to the door.

### Door

The security door and door jamb arrangement may form part of a vault, strong room, safe, security container, toolbox, or like container. Advantageously, the arrangement may be incorporated as part of or in a gun safe.

The door may be adapted to be substantially located inside a door jamb zone when the door is in the closed position. The door may be adapted to be located inward from the door jamb zone when the door is in the closed position such that the door jamb zone is at least in part located outside of the secure space. The door may be adapted to be located inward of the door jamb and overlap the door jamb.

The multiple axis hinge may enable lateral movement of the door relative to the door jamb in a direction which is perpendicular to the hinge axes. The lateral movement of the door relative to the door jamb may enable the door to overlap the door jamb on at least three sides of the door, preferably, all peripheral edges of the door on an internal side of the door jamb, facing the secure space. The door may be adapted to swing outwards, from the secure space, to the outside of the secure space.

### Locking Mechanism

The door and door jamb arrangement may further include a locking mechanism. The locking mechanism may be adapted to actuate locking bolts or other locking features to lock the door to the door jamb. The locking mechanism may also be adapted to actuate the lateral movement of the door relative to the door jamb. The locking mechanism may include a rotating mechanism. The rotating mechanism may be engaged with and actuated by a handle of the locking mechanism. The handle of the locking mechanism may be located on the exterior of the secure space, for example, on an outer side of the door. The locking mechanism may further include an arm which extends between the rotating mechanism and the connection member (such as a rod) of the hinge. The connection member of the hinge may be aligned with a second hinge axis. The locking mechanism may be adapted such that rotating the handle actuates the arm and rotates the second hinge axis about the first hinge axis, therefore effecting the lateral movement of the door.

The arm may include at least two components joined with pivot connections. Preferably, the arm includes a first component extending between the rotating mechanism and a second component. The first component may be attached to the rotating component with a pivot connection. The second component may be attached to the first component with a pivot connection. The second component may be fixed to the rod.

It will be appreciated that any of the features described herein can be used in any combination, and that the invention as described in respect of the second aspect may have the specific features referred to above in respect of the invention as described in respect of the first aspect.

While aspects of the security door arrangement and hinge system will be described for use in combination with each other in the preferred embodiments of the present invention, it is to be understood by a skilled person that some aspects of the present invention are equally suitable for use as standalone inventions that can be individually incorporated into security doors not described herein.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The word “about” or “approximately” when used in relation to a stated reference point for a quality, level, value, number, frequency, percentage, dimension, location, size, amount, weight or length may be understood to indicate that the reference point is capable of variation, and that the term may encompass proximal qualities on either side of the reference point. In some 25 embodiments, the word “about” may indicate that a reference point may vary by as much as 30 percent.

As used herein, the word “substantially” may be used merely to indicate an intention that the term it qualifies should not be read too literally and that the word could mean “sufficiently”, “mostly” or “near enough” for the patentee's purposes.

### BRIEF DESCRIPTION OF THE DRAWINGS

Further aspects of the present invention and further embodiments of the aspects described in the preceding paragraphs will become apparent from the following description. The invention will now be described, by way of non-limiting example only, with reference to the accompanying drawings, in which:

FIG. 1 is a front view of a security safe/container showing a door and door hinge arrangement according to a preferred embodiment of the invention with the door shown in a closed position;

FIG. 2 is a partial view of a top portion of a hinge of the preferred embodiment shown in FIG. 1 as viewed externally to the security safe with the door in a partially open position;

FIG. 3 is a partial view of a lower portion of a hinge of the preferred embodiment shown in FIG. 1 as viewed externally to the security safe with the door in a partially open position;

FIG. 4 is a rear view of the door and door hinge arrangement shown in FIG. 1 as viewed from inside the security safe/container;

FIG. 5 is a rear view of the door and door hinge arrangement shown in FIG. 1 as viewed from inside the container with a locking mechanism in the engaged/locked position;

FIG. 6 is a front view of the door and door hinge arrangement shown in FIG. 1 with the door shown in an unlocked position;

FIG. 7 is a front perspective view of the container with the door shown in the unlocked position;

FIG. 8 is a partial perspective view of a top portion of the hinge arrangement;

FIG. 9 is an upper sectional view of the door and door hinge arrangement forming part of the security container with the door in a transition between the locked and the unlocked position;

FIG. 10 is an upper sectional view of the door and door hinge arrangement forming part of the security container with the external door in an open position swung wide open, where the external surface of the door in this position is opened more than 180° relative to a jamb of the door;

FIG. 11 is an upper sectional view of the door and door hinge arrangement of the security container with the door being retracted from the locked position;

FIG. 12 is an upper sectional view of the door and door hinge arrangement forming part of the security container with the door approaching the locked position;

FIG. 13 is an upper sectional view of the door and door hinge arrangement forming part of the security container with the door in the closed and locked position;

FIG. 14 is a schematic representation from a front view of a 3-dimensional door jamb zone defined by the internal perimeters of a door jamb surrounding an opening of the security container; and

FIG. 15 is a schematic representation from a top sectional view of the door jamb zone.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. In describing the various embodiments of the invention, like features will be referred to using like references, with references for features of each embodiment generally preceded by 1, 2, 3, or followed by a Roman numeric sequence, such as i, ii, iii, etc. or an alphabetical sequence such as a, b, c, relative to the corresponding feature of the first embodiment. For example, a feature 10 of the first embodiment may represented as 110, 210, 310, (or n10), or 10a, 10b, 10c, (or 10x) or 10i, 10ii, 10iii, (or 10r) etc. in second, third and fourth embodiments, respectively.

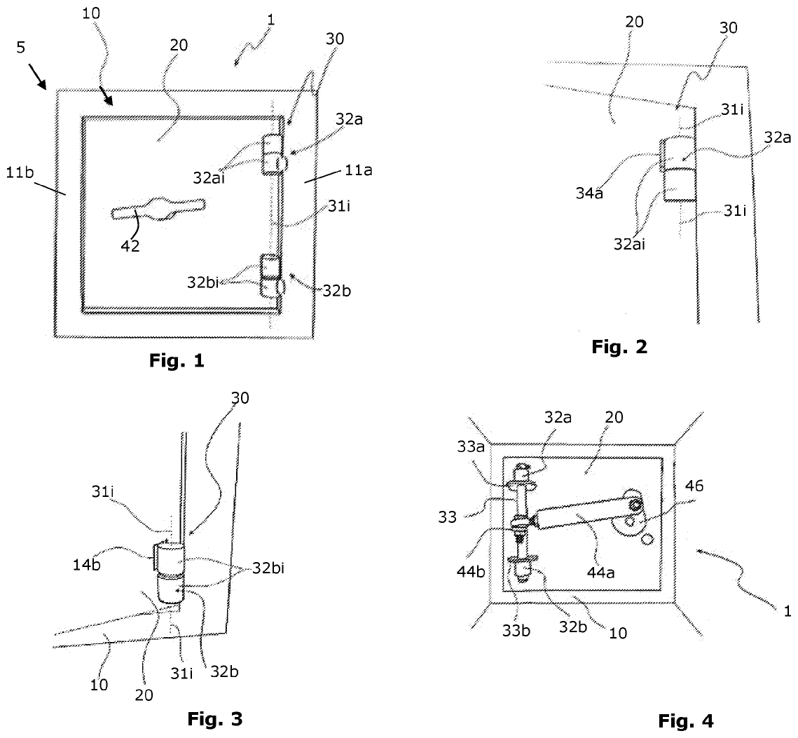

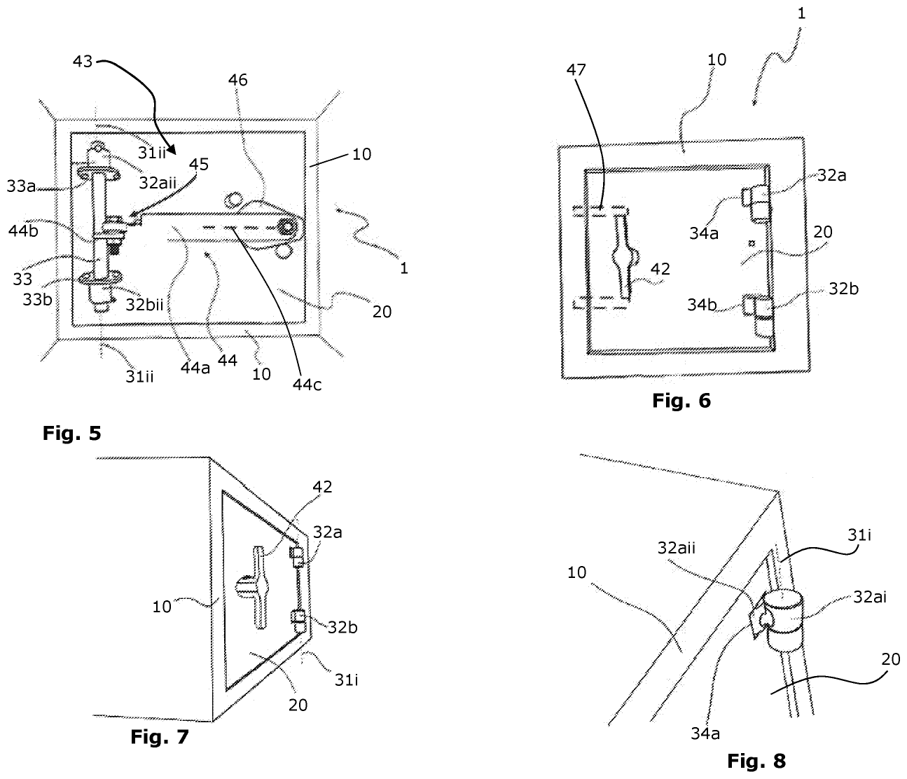

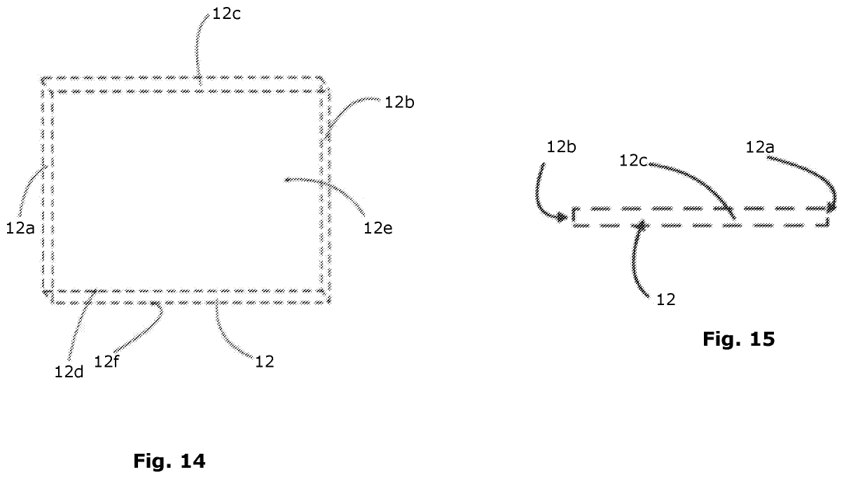

A multi-axis door hinge system 1 for a security container 5 (such as a safe) is shown in FIG. 1 as comprising a door 20, a container frame defining a door jamb 10 and a door hinge system 30. The door hinge system 30 being adapted to hingedly mount the door 20 so that it is supported at a first side 11a of the door jamb 10. In some embodiments, the first side 11a of the door jamb 10 is positioned substantially opposed to a second side 11b of the door jamb 10. Referring to FIG. 14, the door hinge arrangement 1 can be said to have a door jamb zone 12 which is defined as a three-dimensional space between the surrounding peripheral sides of the door jamb 10, comprising top 12c, bottom 12d, first side 12a, second side 12b side, front 12e and rear 12f.

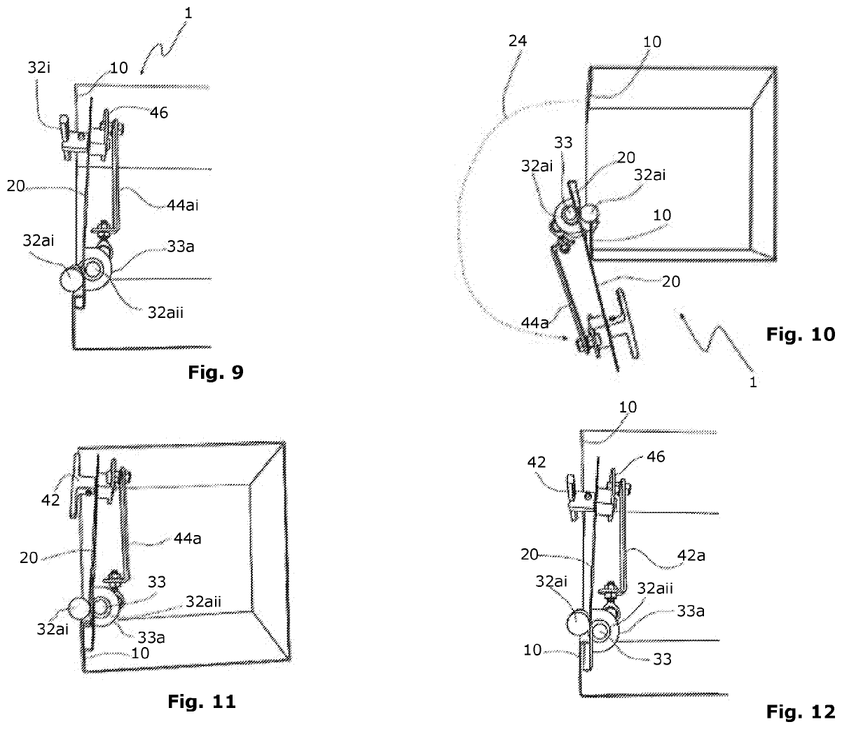

The multi-axis door hinge system 30 comprises at least a first hinge axis 31i and a second hinge axis 31ii. In the preferred embodiment, the axes are non-coaxial with respect to each other. At least one of the first and second hinge axes 31i-ii is located externally (for example outside of the door jamb 10) and at or adjacent the first side 11a of the door jamb 10. The door 20 is adapted to swing about the door hinge system 30 out and away from the second side 11b of the door jamb 10 toward a fully open position (see FIG. 10). As will be described below, the multi-axis hinge system 30 has a first hinge set, comprising at least one or more hinge(s) 32ai, 32bi configured along a first hinge axis 31i, mounted to or proximate an external facing side of the door frame 10 and a second hinge set, comprising one or more hinge(s) 32aii, 32bii configured along a second hinge axis 31ii. The second hinge set 32aii, 32bii is operatively mounted to an internal side of the door 20 so that the door 20 is rotatable about the second hinge axis 31ii. In the preferred embodiment, the second hinge set 32aii, 32bii is operatively coupled with the first hinge set 32ai, 32bi so that the second hinge set 32aii, 32bii is also rotatable about the first hinge axis 31i. This configuration allows the door 20 to move laterally relative to the door (when the door is rotating about the second hinge axis 31ii) as well as a greater rotational movement range (when the door 20 and the second hinge set 32aii, 32bii is rotating about the first hinge axis 31i).

The hinge 30 includes an upper hinge 32a and a lower hinge 32b. Each of the upper and lower hinges 32a-b include a first hinge set 32ai, 32bi and a second hinge set 32aii, 32bii. The first hinge set 32ai, 32bi is aligned with a first hinge axis 31i and the second hinge set 32aii, 32bii is aligned with a second hinge axis 31ii. The second hinge set 32aii, 32bii are connected to each other by an elongated hinge connection member 33 in the form of a rod 33. The hinge connection member 33 extends between the second hinge 32aii of the upper hinge 32a and the second hinge 32bii of the lower hinge 32b through the second hinge axis 31ii. The hinge connection member 33 is housed in two plates 33a,b respectively located at upper and lower ends of the connection member 33, respectively adjacent the upper and lower hinges 32a,b. In some embodiments, the connection member 33 forms part of the second hinges 32aii, 32bii of the upper and lower hinges 32a,b.

In the preferred embodiment, the upper and lower hinges 32ai, 32bi are adapted to extend through holes 34a,b in the door 20 so as to connect with the corresponding hinges 32aii, 32bii on the interior side of the door 20. In some embodiments, the upper and lower hinges 32a,b are not attached or fixed to the holes 34a,b, rather a portion of each of the upper and lower hinges 32a,b is adapted to move relative to, and within, the holes 34a,b.

The first hinge set 32ai, 32bi is mounted to an external side of the door frame 10 so that it is located outside the internal cavity of the container. This allows the door frame 20 to pivot about the first hinge set 32ai, 32bi through a wide opening arc 24 (see FIG. 10). In some embodiments, the door frame 20 can be opened greater than 180° between the closed position, in which the door frame 20 is in contact with the door jamb 10, and a fully swung open position of the door 20. It can be said that the external surface of the door 20 swings out to be entirely outside the door jamb zone 12 in the fully open position. The wide swing of the door 20 provides improved clearance for access to the secure space 2 through the door jamb zone 12.

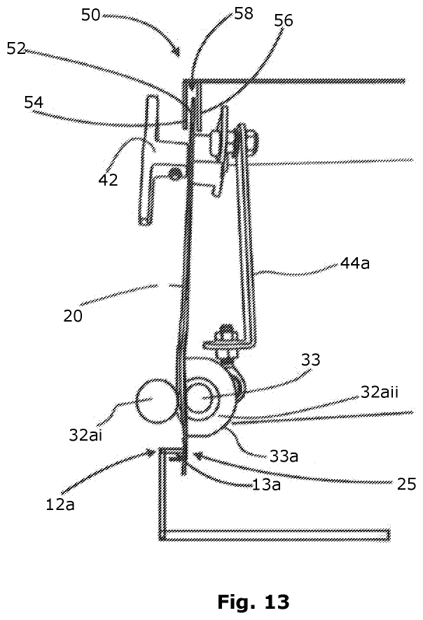

The hinge system 30 is also adapted such that the second hinge axis 31ii can rotate about the first hinge axis 31i due to the hinge 30 being a multi-axis hinge. Therefore, the door 20 is adapted to move laterally relative to the door jamb 10. Referring also to FIG. 13, the door 20 is adapted to move from an unlocked position (shown in FIG. 12) where a remote edge 52 of the door 20 is not overlapping the door jamb 10 to a locked position (shown in FIG. 9) where the remote edge 52 of the door 20 is overlapping the door jamb 10. Due to the mounting location of the hinge 30 relative to the door 20 and the door jamb 10, a hinged edge 25 of the door 20 is adapted to overlap the hinged side of the door jamb 12a in both the locked and unlocked positions of the door 20. The door 20 is adapted to overlap the door jamb 10 on an internal side (second side) 13a of the door jamb 10 which faces the secure space 2.

In the preferred embodiment, the door and door hinge arrangement 1 further comprises a locking mechanism 40. The locking mechanism 40 is adapted to both lock the door 20 to the door jamb 10 and to actuate movement of the door 20 relative to the door jamb 10. The locking mechanism 40 includes a handle 42 mounted on an exterior side of the door 20. The handle 42 is connected to a rotating mechanism 46 on an internal side of the door 20. The locking mechanism 40 further includes an arm 44 which is attached to the rotating member 46 and the hinge connection member 33.

In one embodiment, the arm 44 includes a first member 44a and a second member 44b. The first member 44a is attached to the rotating member 46 with an off-centre pivot connection 43. The second member 44b is attached to the first member 44a with a second pivot connection 45 and fixed at another end to the hinge connection member 33. The locking mechanism 40 is so configured that when the handle 42 is rotated, locking bolts 47 (schematically shown in FIG. 6) lock the door to the door frame or door jamb 10. An arrangement of the security container 5 by the Applicant's illustrating an efficacious locking bolt arrangement suitable for this invention is shown and described in Publication No. WO2017143385, the entire contents of which are hereby incorporated herein by reference). Furthermore, as the handle 42 is rotated, the rotating member 46 rotates, which pushes or pulls the first arm 44a away from or toward the hinge connection member 33 causing the second pivot connection to reciprocally travel and rotate about the second arm 44b. The longitudinal movement (in a direction generally parallel to the first arm's longitudinal axis 44c of the arm 44 therefore rotates the connection member 33, causing lateral sideways movement of the door 20 relative to the door jamb 10 (door frame). The connection member 33 is fixed to the first and second hinges of the upper and lower hinges 32ai, 32bi, 32aii, 32bii and rotates with the plate members 33a,b.

In the present specification, terms such as “apparatus”, “means”, “device” and “member” may refer to singular or plural items and are terms intended to refer to a set of properties, functions or characteristics performed by one or more items or components having one or more parts. It is envisaged that where an “apparatus”, “means”, “device” or “member” or similar term is described as being a unitary object, then a functionally equivalent object having multiple components is considered to fall within the scope of the term, and similarly, where an “apparatus”, “assembly”, “means”, “device” or “member” is described as having multiple components, a functionally equivalent but unitary object is also considered to fall within the scope of the term, unless the contrary is expressly stated or the context requires otherwise. In the present specification, the phrase “and/or” refers to severally or any combination of the features. For example, the phrase “feature 1, feature 2 and/or feature 3” includes within its scope any one of the following combinations: Feature 1 or feature 2 or feature 3; feature 1 and feature 2 or feature 3; feature 1 or feature 2 and feature 3; feature 1 and feature 3 or feature 2; feature 1 and feature 2 and feature 3.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the top side uppermost.

It will be understood that the invention disclosed and defined in this specification extends to all alternative combinations of two or more of the individual features mentioned or evident from the text or drawings. All of these different combinations constitute various alternative aspects of the invention.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

### REFERENCE KEY

Door hinge system 1
Secure space 2
Container 5
Door jamb 10
First side of the door jamb 11a
Second side of the door jamb 11b
Door jamb zone 12
Door jamb first side, second side, top, bottom, front, back extents 12a-f
Inner edge (of the door jamb) 13a
Door 20
Swing (of the door) 24
Hinged edge (of the door) 25
Door hinge/hinge/multi-axis hinge 30
First hinge axis 31i
Second hinge axis 31ii
First hinge set 32ai, 32bi
Second hinge set 32aii, 32bii
Upper hinge 32a
Lower hinge 32b
First hinge (of the upper hinge) 32ai
Second hinge (of the upper hinge) 32aii
First hinge (of the lower hinge) 32bi
Second hinge (of the lower hinge) 32bii
Hinge connection member (rod) 33
Two plates 33a,b
Holes in the door (holes) 34a,b
Portion of the upper and lower hinges 35a,b
Locking mechanism 40
Handle 42
Off-centre pivot connection 43
Arm 44
First member (of the arm) 44a
Second member (of the arm) 44b
First arm's longitudinal axis 44c
Second pivot connection 45
Rotating member 46
Locking bolts 47

1. A multi-axis door hinge system for a container, the system comprising:
a door for enclosing a door frame of the container;
a first hinge set, comprising one or more hinge(s) configured along a first hinge axis, mounted to or proximate an external side of the door frame; and
a second hinge set, comprising one or more hinge(s) configured along a second hinge axis, operatively mounted to an internal side of the door such that the door is rotatable about the second hinge axis,
wherein the second hinge set is operatively coupled with the first hinge set so that the second hinge set is rotatable about the first hinge axis, thereby allowing both lateral and rotational movements of the door relative to the door frame.

2. The multi-axis door hinge system of claim 1, wherein the door is configured to have a movement range of greater than 180° between a closed position, in which the door engages the door frame, and a fully open position.

3. The multi-axis door hinge system of claim 1, wherein the first hinge set and the second hinge set are coupled by a connecting part extending through an opening in the door.

4. The multi-axis door hinge system of claim 1, wherein the second hinge set comprises two hinges and wherein the hinges are coupled by an elongate hinge connection member.

5. The multi-axis door hinge system of claim 4, wherein the second hinge set and/or the hinge connection member are coupled to the door by a plate member.

6. The multi-axis door hinge system of claim 4, further comprising a locking mechanism actuable to move one or more locking bolts relative to the door frame.

7. The multi-axis door hinge system of claim 6, wherein the locking mechanism comprises a handle mounted to an external side of the door for actuating the locking bolts.

8. The multi-axis door hinge system of claim 7, wherein the locking mechanism comprises an arm connecting the handle to the hinge connection member so that actuation of the locking mechanism by the handle effects rotation of the door relative to the second hinge set.

9. A security container, comprising a container frame defining an enclosed space with an opening, and a multi-axis door hinge system as claimed in claim 1 for securing the opening.

10. The multi-axis door hinge system of claim 4, wherein the second hinge set and/or the hinge connection member are coupled to the door by a plate member, further the system includes a locking mechanism actuable to move one or more locking bolts relative to the door frame, wherein the locking mechanism comprises an arm connecting a handle to the hinge connection member so that actuation of the locking mechanism by the handle effects rotation of the door relative to the second hinge set.

11. The multi-axis door hinge system of claim 1, wherein the door is configured to have a movement range of greater than 180° between a closed position, in which the door engages the door frame, and a fully open position, wherein the first hinge set and the second hinge set are coupled by a connecting part extending through an opening in the door.
